(19) United States
(12) Patent Application Publication
(10) Pub. No.: US 2007/0278305 A1
(43) Pub. Date: Dec. 6, 2007

(54) Barcode image generating apparatus and method of generating barcode image

(75) Inventor: Yoshio Komaki, Nishinomiya-shi (JP)

Correspondence Address: SIDLEY AUSTIN LLP, 717 NORTH HARWOOD, SUITE 3400, DALLAS, TX, 75201, US

(73) Assignee: KONICA MINOLTA HOLDINGS, INC.

(21) Appl. No.: 11/807,625

(22) Filed: May 30, 2007

(30) Foreign Application Priority Data
Jun. 6, 2006 (JP) 2006-157018

(51) Int. Cl. G06K 7/10

(52) U.S. Cl. 235/462.01

(57) ABSTRACT

A barcode image generating apparatus and barcode image generating method capable of generating a barcode image containing an adequate visual expression conforming to the barcode contents. A meaningful feature related to the barcode description is extracted and the visual expression specification is determined based on this feature, whereby a barcode image is generated in conformity to the visual expression specification.

This application is based on Japanese Patent Application No. 2006-157018 filed on Jun. 6, 2006, in Japanese Patent Office, the entire content of which is hereby incorporated by reference.

### TECHNICAL FIELD

The present invention relates to a barcode image generating apparatus for generating a barcode image wherein information is contained in the image pattern, and a method of the generating a barcode image.

### BACKGROUND

Recent years have witnessed a widespread use of a barcode system wherein striped pattern images of bars (black lines) and spaces (white or background colors) are associated with and replaced with numerals, characters and symbols so that the information can be automatically read from the pattern image by machines.

In such a barcode system, the barcode image is printed on paper, plastics and other media, whereby the information such as an identification number and order number to be read by the machine can be accurately inputted in the system without requiring time and effort. FIG. 21 (a) shows the examples of such barcodes. The reference numeral 41 of FIG. 21 (a) denotes a barcode representing a general bar and space pattern, and 42 indicates a two-dimensional barcode that has come into frequent use in recent years.

Such a conventional barcode having been used in the factory as intended in the beginning has come to be used in a more extensive range in the way the barcode is included in part of the meaningful image for users exemplified by printed matter, home page, ticket, product package, image for cellular mobile telephone and TV image. FIG. 21 (b) shows the example 43 additionally printed on the document image, and the example 44 expressing the input image by the cellular mobile telephone.

In this manner, when a barcode image is added as part of the item or image meaningful to a user, the user is provided with wide-ranging applications. For example, the user can refer to the related information through the Web or can easily input the telephone number and URL address using the apparatus such as a cellular mobile telephone having a barcode reading function.

When such an application is assumed, the user is required to identify the barcode image and actively read out the barcode image. However, the image itself of the conventional barcode has not been considered as an object to be identified by humans and has been meaningless and difficult to identify. Although the barcode is recognizable as a barcode to the user, identification of the contents is not possible. It is considered only as an object of an reading operation by a machine. In some cases, the contents having been read by spending time and labor are found to be different from the expected contents.

To solve the aforementioned problems, efforts have been made to develop a technique that gives expression for visual identification to the barcode image (e.g., Japanese Registration Patent No. 3336311).

Japanese Registration Patent No. 3336311 proposes the technique wherein a color barcode is used to read the information by the arrangement of the colors of the cells constituting the barcode image. In such a system, if only the arrangement of colors for each cell required for reading is provided, free designing of the color, shape, size and background color can be ensured to provide a meaningful form of barcode images that can be visually identified by the user.

FIG. 21 (c) shows an example of the color barcode. The reference numeral 45 denotes the color barcode made up of 5×5 cells. In each cell color arrangement, four colors R, G, B and Bk (red, green, blue and black) shown in 31a are arranged. For example, the form visually significant to humans as the overall image can be obtained by deforming the shape and dimensions of each cell, without losing the machine readability.

However, there has been no simple method for adequately setting the visual expression of such a color barcode in response to the content of a barcode. Uniform designing of the color barcode cannot be achieved. At present, a great number of man-hours by human labor must be used for each case. Thus, in the visual expression of the color barcode, a small number of fixed designs, such as the logo design of a private company, not directly related to the content expressed by the barcode have been used in many cases.

In this context, there has been an intense demand for an apparatus and method capable of converting the visual expression of the color barcode into the form conforming to the content represented by the barcode, whereby this expression can be easily formed as a barcode image.

As described above, when the barcode image is provided with the visual expression, the user can predict the results of reading free from anxiety. However, the conventional art has failed to provide the apparatus and method capable of easy designing of the visual expression suitable to the content represented by the barcode image.

### SUMMARY

An object of the present invention is to solve the aforementioned problems and to provide a barcode image generating apparatus and a barcode image generating method capable of easy generation of the barcode image equipped with the visual expression conforming to the content of the barcode. In view of forgoing, one embodiment according to one aspect of the present invention is a barcode image generating apparatus, comprising:

a barcode image generation section which generates a barcode based on a barcode ID;

a feature input section which inputs a meaningful feature related to the barcode image; and

a visual expression determination section which determines a visual expression specification of the barcode image based on the meaningful feature inputted by the feature input section,

wherein the barcode generating section generates a basic barcode image based on the barcode ID, and generates the barcode by having the visual expression specification determined by the visual expression determination section be reflected in the basic barcode.

According to another aspect of the present invention, another embodiment is a method of generating a barcode image, the method comprising the steps of:

generating the barcode image based on a barcode ID;

inputting a meaningful feature related to the barcode image; and

determining a visual expression specification of the barcode image based on the meaningful feature inputted in the step of inputting a meaningful feature,

wherein in the step of generating a barcode image, generating a basic barcode image based on the barcode ID, and generating the barcode by having the visual expression specification determined by the visual expression determination section be reflected in the basic barcode.

### BRIEF DESCRIPTION OF THE DRAWINGS

FIG. 1 is a block diagram representing the approximate functional structure of the barcode image generating apparatus of the present embodiment;

FIG. 2 is a block diagram representing the approximate structure of the printers 1 and 2 containing the barcode image generating apparatus of the first and second embodiments;

FIG. 3 is a flow chart representing the operation flow of the printers 1 and 2 containing the barcode image generating apparatus of the first and second embodiments;

FIG. 4 is a block diagram representing the approximate structure of the barcode image generating apparatus 10 with reference to a printer 1;

FIG. 5 is a flow chart representing the operation flow of the process of determining visual expression in Step S30 of FIG. 3 and FIG. 18 with reference to printers 1 and 4;

FIG. 6 is a flow chart showing the operation flow in the process of generating the barcode image in the Step S40 of FIG. 3 and FIG. 14 with reference to printers 1, 2 and 3;

FIG. 7 is a diagram showing an example of processing in the flow chart of FIG. 6 with reference to the printer 1;

FIG. 8 is a flow chart showing the operation of adjustment process of synthesis in the flow chart of FIG. 6 with reference to printers 1 and 2;

FIG. 9 is a diagram showing another example of processing in the flow chart of FIG. 6 with reference to printer 1;

FIG. 10 is a block diagram representing the approximate structure of the barcode image generating apparatus 10 with reference to a printer 2;

FIG. 11 is a flow chart representing the operation flow of the process of determining visual expression in Step S30 of FIG. 3 with reference to print 2;

FIG. 12 is a diagram showing another example of processing in the flow chart of FIG. 6 with reference to a printer 2;

FIG. 13 is a block diagram representing the approximate structure of the printer 3 containing the barcode image generating apparatus of the third embodiment;

FIG. 14 is a flow chart representing the operation flow of the printer 3 containing the barcode image generating apparatus of the third embodiment;

FIG. 15 is a block diagram representing the approximate structure of the barcode image generating apparatus 10 with reference to a printer 3;

FIG. 16 is a flow chart representing the operation flow of the process of determining visual expression in Step S30 of FIG. 14 with reference to printer 3;

FIG. 17 is a block diagram representing the approximate structure of the printer 4 containing the barcode image generating apparatus of the fourth embodiment;

FIG. 18 is an operation flow representing the approximate structure of the printer 4 containing the barcode image generating apparatus of the fourth embodiment;

FIG. 19 is a block diagram representing the approximate structure of the barcode image generating apparatus 10 with reference to a printer 4;

FIG. 20 is a flow chart showing the operation flow of the process of generating a barcode image in Step S40 of FIG. 18 with reference to a printer 4; and

FIGS. 21 (a), 21 (b) and 21 (c) are the diagrams representing specific examples of a barcode.

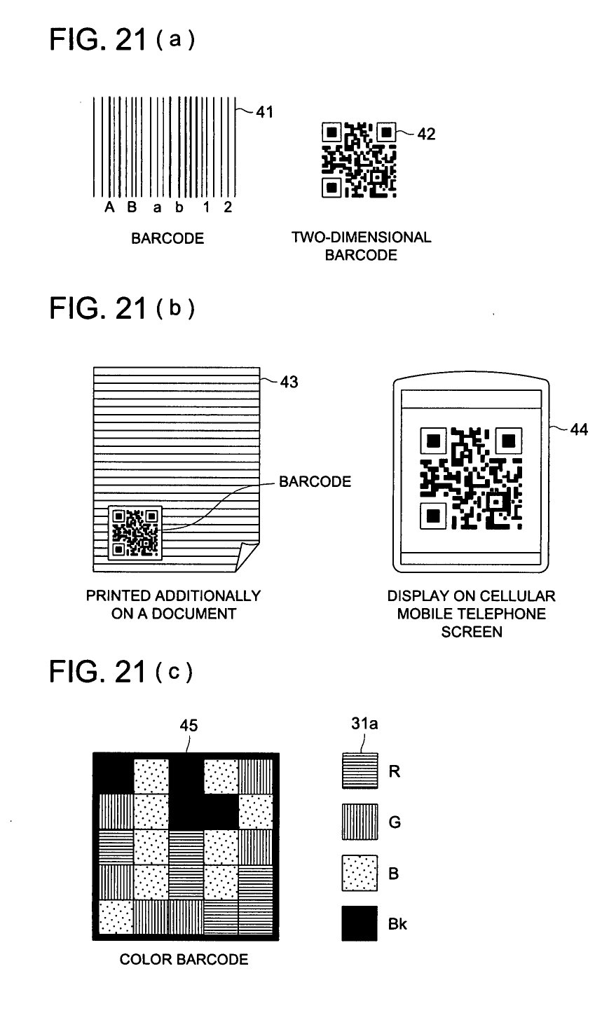

### DETAILED DESCRIPTION OF THE PREFERRED EMBODIMENT

The following describes the embodiments of the present invention with reference to drawings. It is to be expressly understood, however, that the present invention is not restricted thereto. The present invention can be embodied in a great number of variations with appropriate modification or additions, without departing from the technological spirit and scope of the invention claimed.

### (Approximate Functional Structure of Barcode Image Generating Apparatus)

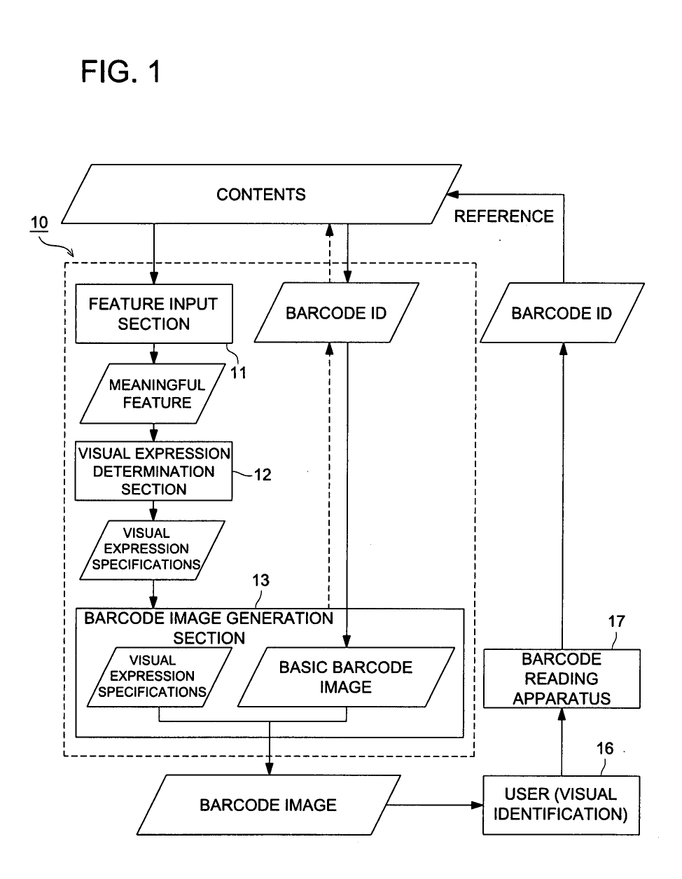

FIG. 1 is a block diagram representing the approximate functional structure of the barcode image generating apparatus of the present embodiment. Referring to FIG. 1, the following describes the approximate structure of the barcode image generating apparatus.

In FIG. 1, 10 denotes a barcode image generating apparatus. The barcode image generating apparatus 10 includes a feature input section 11, visual expression determination section 12, barcode image generation section 13 and others.

For visual representation, by the barcode image itself, of the feature on the contents to be expressed by a barcode image in addition to the ID information (barcode ID) of the contents, the feature input section 11 extracts the contents features and inputs them into the visual expression determination section 12. The features to be extracted are exemplified by a character code included in the contents, an image feature included in the contents, or URL domain of the contents. Such data is inputted into visual expression determination section 12 as the meaningful feature of the content.

The visual expression determination section 12 has a feature dictionary conforming to each of the types of the meaningful features to be received, and is used to search for a related feature. It also has an expression pattern dictionary for the feature having been found out and searches for the corresponding expression pattern image. For synthetic processing of the searched expression pattern as the visual expression of the barcode image, the visual expression determination section 12 sends it to the barcode image generation section 13 as the visual expression specifications.

Assume, for example, that the meaningful feature is the text data of the contents. A search operation is performed to see whether or not the text data having received contains the character code conforming to the feature keyword described in the feature keyword dictionary. Based on the feature keyword having been found out, expression pattern dictionary is searched and the corresponding expression pattern image is extracted. Specific examples will be described later.

Based on the barcode ID for specifying the contents, the barcode image generation section 13 generates a basic barcode image, and a expression pattern image as a visual expression specifications having received from the visual expression determination section 12 is synthesized on the basic barcode image, whereby the barcode image having the visual expression is produced. This corresponds to the barcode image representing the barcode ID provided with the visual expression representing the feature of the contents.

As will be described later, it is also possible to make such arrangements that the barcode image having the visual expression is generated directly from the visual expression specifications, viz., the expression pattern, and the barcode ID corresponding thereto is determined. Then it is given to the contents later on. (This is shown by the flow given by a broken line in FIG. 1). Such processing flow will be described later with reference to the specific examples of the synthesis of the visual expression.

The above is the approximate description of the functional elements constituting the barcode image generating apparatus 10. This is intended to achieve the basic flow wherein the corresponding barcode image based on the content is generated, and is read, whereby the barcode ID (typically, the URL of the contents) is obtained to allow access to the corresponding contents itself.

This object can be achieved merely by reading the barcode ID from the barcode image. In the present embodiment, the barcode image itself has a visual expression, and the user can identify the feature of the visually corresponding contents. Accordingly, the contents to be obtained can be predicted to a certain extent in advance, and therefore, the barcode reading operation can be performed free from anxiety. Further, depending on the case, it is possible to omit the reading that is not expected, thereby saving time and labor.

FIG. 1 shows both the user 16 and barcode reading apparatus 17. The user 16 visually identifies the barcode image generated and outputted by the barcode image generating apparatus 10, and checks the feature to predict if the desired contents is present or not. Based on this prediction, the user performs the operation of reading the barcode image using the barcode reading apparatus 17, with a certain degree of confidence as to the result. Thus, the user gets the barcode ID and accesses the corresponding content.

As the barcode image is used in the aforementioned process, the barcode image generating apparatus 10 is not used independently. It is connected to the printer directly or via the network. Such data is printed on various types of media as a barcode or is printed after having been superimposed onto other printing document and printed images.

Further, the barcode image is generated on the server, Web homepage or PDF document, and is stored or used as electronic data. It is displayed on the terminal apparatus of PDA, electronic paper and many others. Thus, there are various forms of usage of the barcode image generating apparatus 10 as an apparatus.

As described above, the barcode image generating apparatus 10, can be connected with a printer, or a printer can incorporate the barcode image generating function. Thus, the barcode image generating apparatus 10 can be incorporated in another apparatus.

The following describes some embodiments wherein the barcode image generating apparatus 10 is incorporated in a printer:

### FIRST EMBODIMENT

The following describes the first embodiment wherein the printer 1 incorporating the barcode image generating apparatus:

### <Structure of Printer 1>

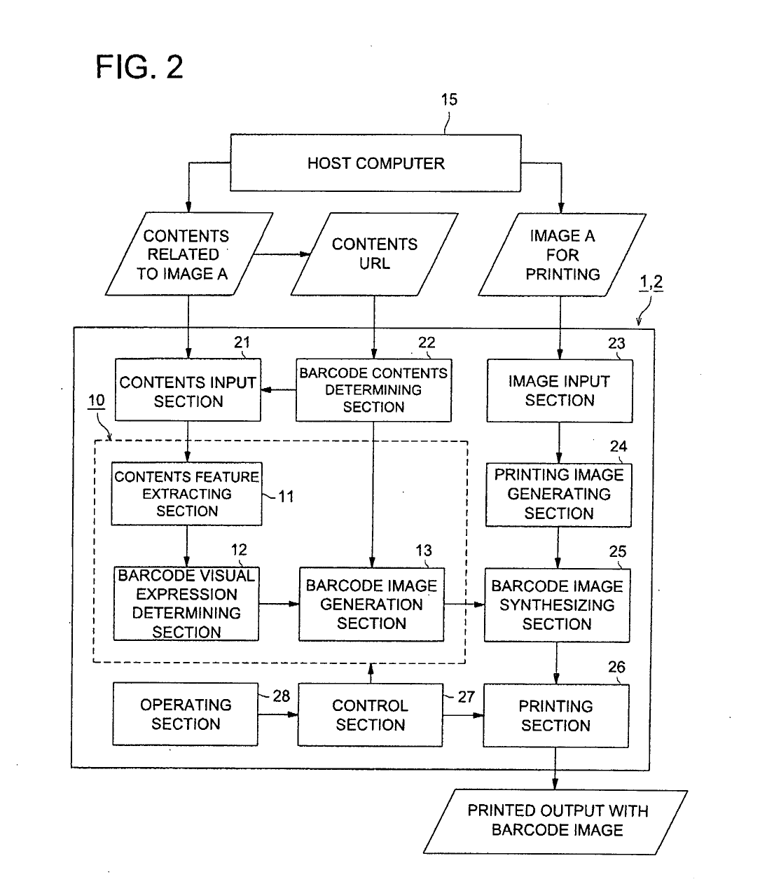

FIG. 2 is a block diagram representing the approximate structure of the printer 1 containing the barcode image generating apparatus of the first embodiments. Referring to FIG. 2, the following describes the printer 1 containing the barcode image generating apparatus:

In FIG. 2, 10 denotes a barcode image generating apparatus. The barcode image generating apparatus 10 contains a contents feature extracting section 11, barcode visual expression determination section 12, and barcode image generation section 13.

The printer 1 incorporating the barcode image generating apparatus 10 acquires from the host computer 15 the printing image A to be produced as a printed output by the printer and the contents to be accessed in connection with the image A. Further, it also acquires the barcode ID (typically the URL of the content) to be outputted as a barcode image for access to the contents, together with the image A.

The barcode image generating apparatus has functions of converting this barcode ID into a barcode image, extracting the feature from the contents and synthesizing it on the barcode image as a visual expression.

The following describes the function of each component of the printer 1:

The reference numeral 22 denotes a barcode contents determining section, which determines the data represented by the barcode. It is a so-called barcode ID, and is the information for specifying the corresponding contents. It should be noted that, in the present embodiment, the URL of the contents is used unless otherwise specified.

The reference numeral 21 indicates a contents input section. It is used to input the picture image through the barcode contents determining section 22 based on the barcode ID, viz., URL of the contents. Acquisition of contents is intended to extract the significant feature of the content. The picture image of the contents is inputted into the barcode image generating apparatus 10.

Further, the barcode ID, viz., contents URL, is also inputted into the barcode image generating apparatus 10 by the barcode contents determining section 22.

The function of the barcode image generating apparatus 10 is as already described. The contents feature extracting section 11 serves as a feature input section for inputting the meaningful feature based on the inputted contents. The barcode visual expression determination section 12 serves as a visual expression determination section that determines the visual expression specifications based on the contents feature. The barcode image generation section 13 serves as a barcode image generation section of the present invention that generates the barcode image, based on the barcode ID and visual expression specifications.

The reference numeral 23 indicates an image input section to acquire the image A for printing. The image A for printing is a target image that is to be printed out, and as a format of the image A various forms are available as long as a general printer can input the format. The barcode image is added to the part of the printed output of this image A on the medium.

The reference numeral 24 indicates a printing image generating section for printing. Various forms of the images A for printing that have been acquired by the image input section 23 are converted into the image data to be printed. For example, the image data of CMYK2 value is generated at a resolution suited to the printing section 26 (to be described later).

The reference numeral 25 indicates a barcode image synthesizing section. The barcode image generated by the barcode image generating apparatus 10 is superimposed on the image data for printing generated by the printing image generating section 24.

The reference numeral 26 denotes a printing section. The image for printing with the barcode image superimposed thereon by the barcode image synthesizing section 25 is printed and outputted on the recording medium such as paper.

The reference numeral 27 is a control section that controls the execution of the aforementioned function of the printer 1, and 28 is an operation section. This allows the user to be involved in the content of control via the interface (not illustrated). For example, the barcode image generated by the barcode image generating apparatus 10 is shown on the display and printing operation can be performed in response to the key input denoting the confirmation by the user.

### <Operation Flow of Printer 1>

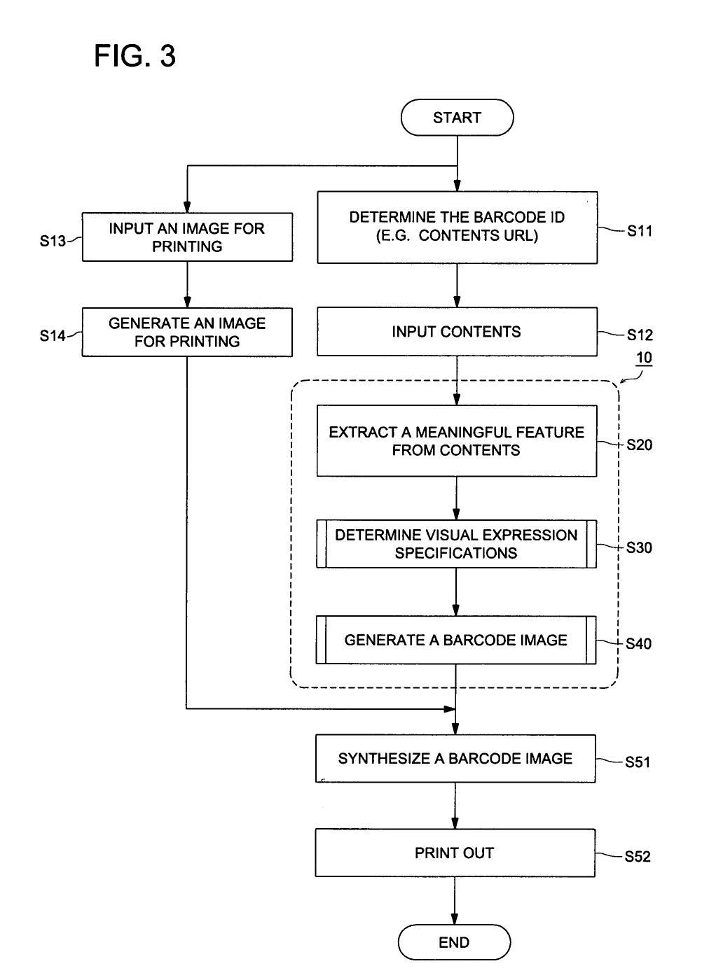

FIG. 3 is a flow chart representing the operation flow of the printer 1 containing the barcode image generating apparatus. Referring to FIG. 3, the following describes the operation flow of outputting the print with a barcode image by means of the printer 1 including the barcode image generating apparatus. Reference will be made to FIG. 2, as required.

In Step S11, the barcode ID is determined as the contents of barcode by the barcode contents determining section 22. Here it corresponds to the URL of the contents to be referred to by the barcode. In Step S12, the picture image of the contents is inputted by the content input section 21, based on the barcode ID.

In Step S13, the image A for printing is acquired by the image input section 23. In the next Step S14, the acquired image A for printing is converted into the image data to be printed by the printing image generating section 24.

A barcode image is generated in the next Step S20, Step S30 and Step S40 based on the picture image of the contents acquired in Step S11 and Step S12, and the ID (URL) thereof. To be more specific, the operation of generating the barcode image by the barcode image generating apparatus 10 is performed in Step S20, Step S30 and Step S40.

Step S20 is a feature input process, wherein the contents feature extracting section 11 extracts the meaningful feature from the inputted content. Step S30 is a visual expression determining process wherein the barcode visual expression determination section 12 determines the visual expression specifications from the contents feature. Step S40 is a barcode image generating process wherein the barcode image generation section 13 generates a barcode image based on the barcode ID and visual expression specifications.

In the next Step S51, the barcode image generated by the barcode image generating apparatus 10 is superimposed on the image for printing acquired in Step S14 by the barcode image synthesizing section 25. In the final Step S52, the image A for printing with the barcode having been superimposed thereon is printed out by the printing section 26.

### <Structure of Barcode Image Generating Apparatus 10 and Operation Flow>

Referring to drawings, the following describes the more detailed structure of the barcode image generating apparatus 10 of the printer 1, and the operation flow.

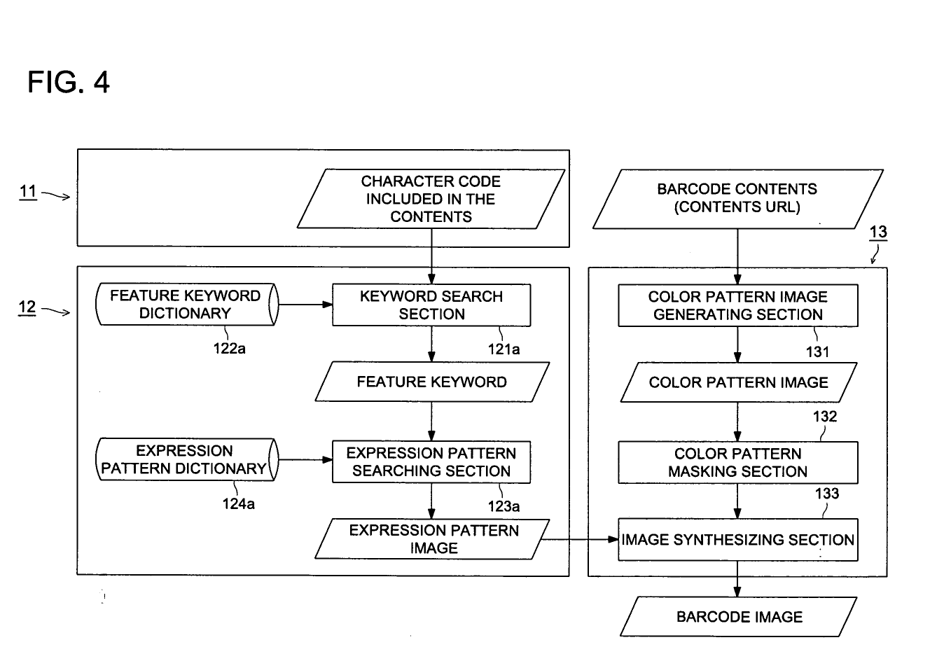

FIG. 4 is a block diagram representing the approximate structure of the barcode image generating apparatus 10 with reference to a printer 1. Referring to FIG. 4, the following describes the approximate structure of the barcode image generating apparatus 10.

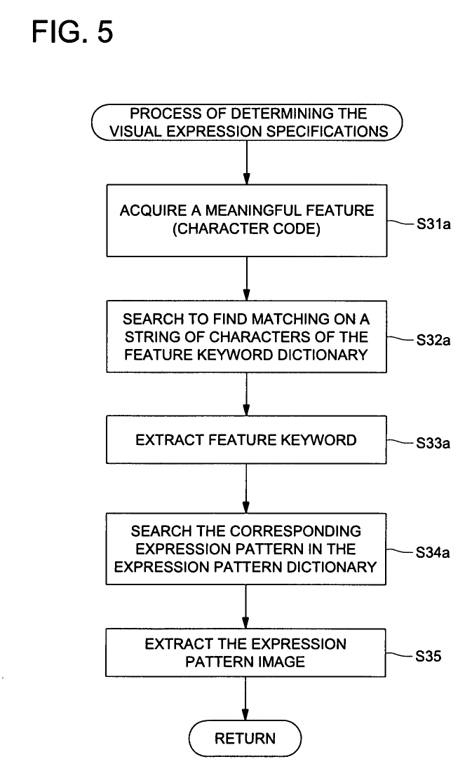

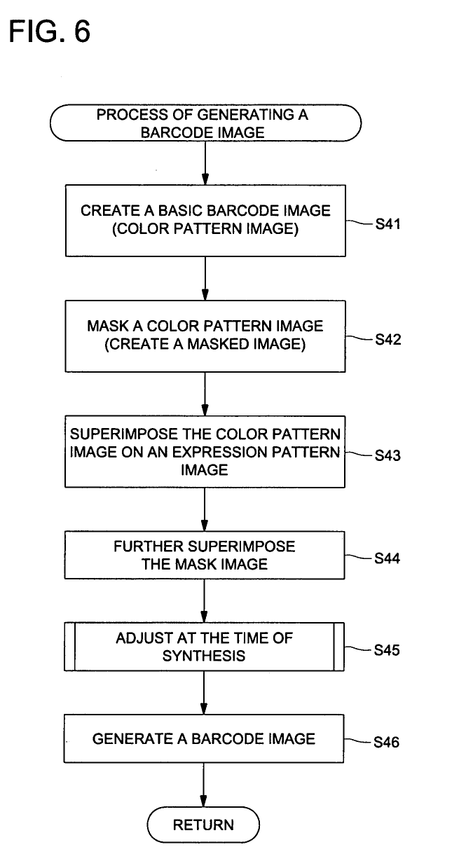

The following describes the operation flow of each process with reference to FIG. 5 and FIG. 6:

FIG. 5 is a flow chart representing the operation flow of the process of determining visual expression corresponding to Step S30 of FIG. 3. FIG. 6 is a flow chart showing the operation flow in the process of generating the barcode image corresponding to Step S40 of FIG. 3.

The barcode image generating apparatus 10 of FIG. 4 includes a contents feature extracting section 11, the barcode visual expression determination section 12, and the barcode image generation section 13.

The contents feature extracting section 11 extracts the character code as a meaningful feature from the picture image of the content having been acquired. In Step S31a, the character code is handed over to the barcode visual expression determination section 12.

The barcode visual expression determination section 12 includes a keyword search section 121a, feature keyword dictionary 122a. The feature keyword dictionary 122a includes a plurality of feature keywords, and the keyword search section 121a searches the character string of the content obtained from the contents feature extracting section 11 to find out the character code corresponding to the feature keyword (Step S32a), and extracts the corresponding feature keyword (Step S33a).

The barcode visual expression determination section 12 is further equipped with an expression pattern search section 123a and expression pattern dictionary 124a. The expression pattern dictionary 124a contains an expression pattern image in response to each feature keyword. The expression pattern search section 123a searches the expression pattern dictionary 124a to find out the expression pattern image corresponding to the feature keyword extracted from the keyword search section 121a (Step S34), and extracts the corresponding expression pattern image (Step S35).

The barcode image generation section 13 includes a color pattern image generating section 131, color pattern masking section 132, and image synthesizing section 133. Based on the barcode ID (URL), the color pattern image generating section 131 generates the color pattern image as a basic barcode image (Step S41). The color pattern image can be created by a conventional method. The following description is based on the method known as a color zip specification.

In the meantime, the color pattern masking section 132 masks the color pattern image (Step S42). This is used to ensure that the color pattern image, viz., information included in the barcode, is not damaged when an expression pattern image is synthesized later.

The image synthesizing section 133 superimposes an expression pattern image onto the color pattern image (Step S43). The expression pattern image is a visual expression such as text data, and a visual expression is applied to the barcode (e.g., the characters of the expression pattern can be read).

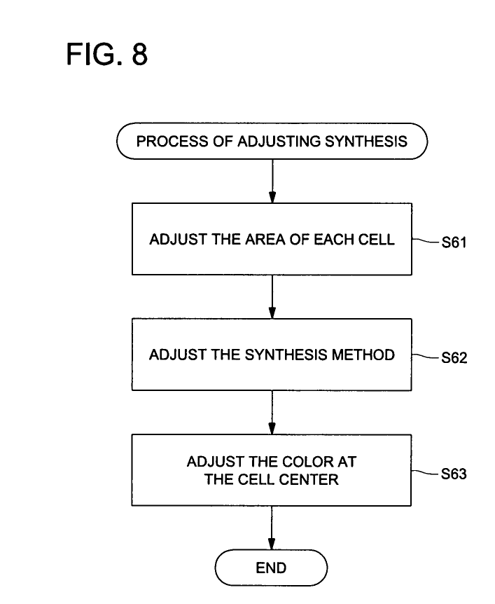

The image synthesizing section 133 again superimposes the masked color pattern image obtained in Step S42, onto the color pattern image superimposed as obtained in Step S43 (Step S44). Even if the information is damaged in the first synthesis, the damage can be repaired by this process. Further, when synthesis is carried out, various adjustments are made to maintain information (Step S45). The details of adjustment will be explained later with reference to FIG. 8.

Thus, the barcode image as the output of the barcode image generating apparatus 10 is generated (Step S46).

The description of the generation of a barcode image is now complete.

### <Example of Generating the Barcode Image by Barcode Image Generating Apparatus 10>

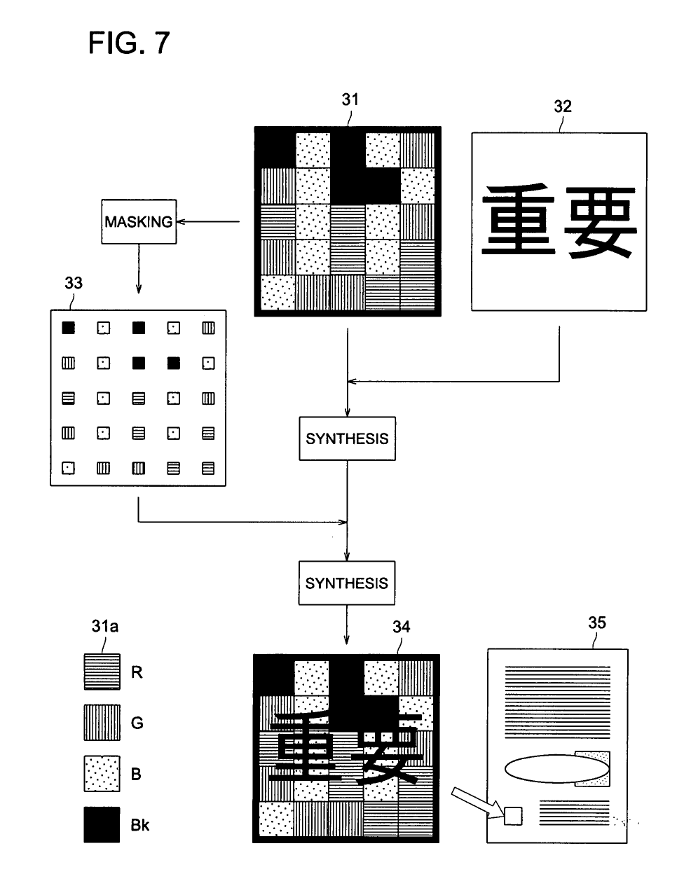

Referring to FIG. 7, the following describes an example of generating a barcode image by the barcode image generating apparatus 10 of the printer 1. FIG. 7 is a diagram showing the process of generating a color barcode and superimposing an expression pattern thereon, whereby the barcode image is provided with a visual expression. It corresponds to the processing of the flow chart in FIG. 6.

Assume the following procedure in the preceding step: The feature keyword dictionary 122a retains the keyword of “PRESIDENT”. Matching with the character string of the content has been found out by the keyword search section 121a, and the feature keyword “PRESIDENT” has been extracted according to the frequency thereof or other adequate selection standards.

Then the expression pattern dictionary 124a is searched by the expression pattern search section 123a, and an expression pattern, “IMPORTANT”, corresponding to the feature keyword “PRESIDENT” has been found out. The expression pattern is converted according to the appropriate font dictionary (not illustrated), and the expression pattern image 32 including a designed character “IMPORTANT” is extracted. The expression pattern image 32 represents Japanese kanji characters denoting “IMPORTANT”. These characters contain the intension of visually appearing that it is literally “important”. This is superimposed on the color barcode as a visual expression.

In the meantime, in Step S41 of FIG. 6, the color pattern image 31 as a basic barcode image is created according to the barcode ID by the color pattern image generating section 131. Here a color barcode image will be created based on the color zip specifications. However, any desired conventional method can be used to create the barcode.

In the color zip specifications, a barcode is made up of a plurality of cells arranged in the form of a matrix. Each cell is assigned with its specific color so that the information included in the color arrangement, viz., the barcode ID can be read.

A color pattern image 31 is made up of 5×5 cells, and each cell is assigned with any one of the four colors—R, G, B and BK (red, green, blue and black)—as indicated by 31a.

In Step S42, the color pattern image 31 is masked and the masked color pattern image 33 is obtained. In the masked color pattern image 33, the color arrangement of each cell remains only in a predetermined area at the center of each cell, and is deleted from other areas. This is intended to ensure that the color arrangement remains only in the area essential to read out the information, and colors can be deleted from other areas by superimposition of the expression pattern. This is based on the restriction of the color zip specifications.

In Step S43, an expression pattern image 32 is superimposed on the color pattern image 31. Here a process of superimposition is applied in such a way the portion of “IMPORTANT” is shown in a white patch, namely, color information in the portion is lost. As will be described later, black characters may be used, depending on the degree of brightness of the entire image.

In Step S44, the masked color pattern image 33 is further subjected to a process of synthesis. As described above, color arrangement for the portion essential to read out information is kept undeleted.

As a result, the barcode image 34 containing a visual expression is obtained in Step S46.

Further, this barcode image 34 is superimposed on the image for printing, is produced as a printed output, and is often used as a printed output 35 containing a barcode image.

The following is a supplementary description of the adjustment of the process of synthesis in Step S45 with reference to FIG. 8. FIG. 8 is a flow chart showing the operation of adjustment in synthesis.

In FIG. 8, the area specific to each cell is adjusted in Step S61. When the expression pattern image 32 is superimposed on the color pattern image 31, part of the color arrangement of each cell is lost. However, adjustment is made so that the designated color arrangement will account for 40% or more of the entire cell. This is due to the restriction of the color zip specifications. To put it more specifically, the required conditions are met by the process of reducing the width of the portion of characters of the expression pattern.

In Step S62, adjustment is made of the method for synthesis. This is intended to enhance the user visibility. For example, to enhance the contrast of the character “IMPORTANT”, black characters are used when the portion of color arrangement is bright, whereas a white patch is used for synthesis when the portion of color arrangement is not bright.

In Step S63, adjustment is made to ensure that a predetermined area of the center of each cell will contain the color arrangement designated by the cell. This is also due to the restriction of the color zip specifications. This can be achieved by superimposition of the masked color pattern image 33.

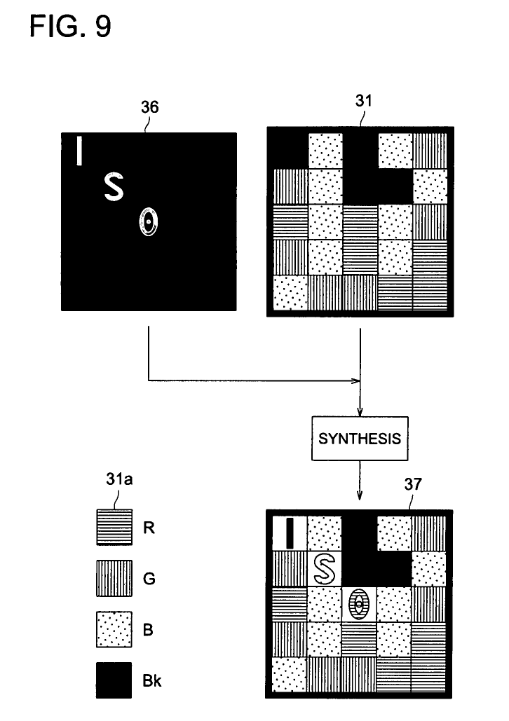

Referring to FIG. 9, the following describes another example of generating a barcode image using the barcode image generating apparatus 10. FIG. 9 shows the process of giving a visual expression to a barcode image by generating the color barcode and superimposing the expression pattern, and corresponds also to the process of shown in the flow chart of FIG. 6.

The difference from the aforementioned description is that alphabets “ISO” are designed as an expression pattern image 36. The color pattern image 31 as a basic barcode image is the same as described above.

The expression pattern image 36 is designed so that each letter of the “ISO” is assigned to a cell, and the center of each cell corresponds to the letter portion at that time. Thus, if color arrangement is given in the letter portion at the time of synthesis, color arrangement at the cell center is ensured, even if mask processing is not performed.

In the case of a string of a Japanese kanji, such processing is difficult. It is also possible to make such arrangements that the expression pattern dictionary 124a is provided with a function of converting the Japanese kanji into corresponding alphabet (letter).

In the synthesized barcode image 37, the designated color arrangement remains in the portion of letter “ISO”. A white background is used to improve the visibility. Thus, the barcode image with visual expression can be generated more simply and efficiently since the process of masking is eliminated.

In the printer 1 incorporating the barcode image generating apparatus 10, the barcode image including a visual expression with an adequate character string designed thereon can be generated simply and effectively in response to the feature keyword of a string of characters included in the content. This can be produced as printed matter. The user of such a printed output is allowed to estimate the description of the content that can be accessed from the barcode by observing a string of characters designed on the barcode. This eliminates the need of accessing an unwanted content, and ensures more effective access to a desired content.

### Second Embodiment

The printer 2 incorporating a barcode image generating apparatus will be explained as a second embodiment:

### <Structure and Operation Flow of Printer 2>

FIG. 2 is a block diagram representing the approximate structure of the printer 2 containing the barcode image generating apparatus as a second embodiment. The difference of the printer 2 from the printer 1 is found only in the barcode image generating apparatus 10, and the other portions are the same. Thus, the approximate structure of the printer 2 incorporating the barcode image generating apparatus will not be described.

In FIG. 2, 10 denotes a barcode image generating apparatus. The barcode image generating apparatus 10 includes a contents feature extracting section 11, the barcode visual expression determination section 12, and the barcode image generation section 13.

The functions of the barcode image generating apparatus 10 have already been described. The contents feature extracting section 11 serves as a feature input section for inputting a meaningful feature from the inputted content. The barcode visual expression determination section 12 serves as a visual expression determination section for determining the visual expression specifications from the contents feature. The barcode image generation section 13 serves as a barcode image generation section of the present invention that generates a barcode image based on the barcode ID and visual expression specifications.

FIG. 3 is a flow chart representing the operation flow of the printer 2 containing the barcode image generating apparatus as a second embodiment. The only difference between the operation of the printer 2 and that of the printer 1 is found in Step S20, Step S30 and Step S40 related to the barcode image generating apparatus 10, and the other portions are the same. Thus, the operation flow of the printer 2 including the barcode image generating apparatus will not be descried.

Step S20 is a feature input process. The contents feature extracting section 11 extracts the meaningful feature from the inputted contents. Step S30 is a visual expression determining process, and the barcode visual expression determination section 12 determines the visual expression specifications from the contents feature. Step S40 is a barcode image generating process. The barcode image generation section 13 generates a barcode image based on the barcode ID and visual expression specifications.

### <Structure and Operation Flow of Barcode Image Generating Apparatus 10>

Referring to FIG. 2, the following provides a detailed description of the structure and operation flow of the barcode image generating apparatus 10 of the printer 2.

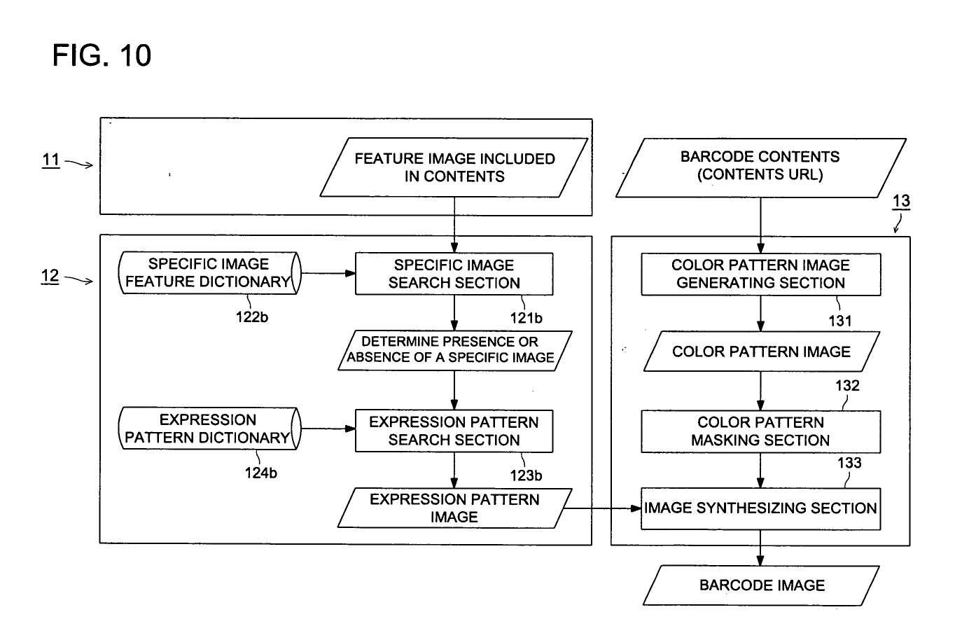

FIG. 10 is a block diagram representing the approximate structure of the barcode image generating apparatus 10 with reference to a printer 2. The following describes the approximate structure of the barcode image generating apparatus 10 with reference to FIG. 10.

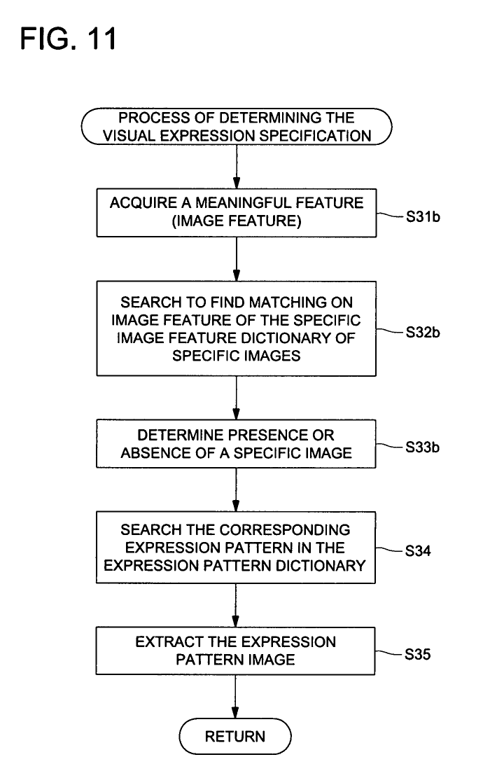

The operation flow of each process will be explained with reference to FIG. 11 and FIG. 6.

FIG. 11 is a flow chart representing the operation flow of the process of determining visual expression in Step S30 of FIG. 3. Similarly, FIG. 6 is a flow chart showing the operation flow in the process of generating the barcode image in the Step S40 of FIG. 3.

The barcode image generating apparatus 10 of FIG. 10 is made up of a contents feature extracting section 11, barcode visual expression determination section 12, and barcode image generation section 13.

The contents feature extracting section 11 extracts an image feature as a meaningful feature from the picture image of the acquired contents. In Step S31b, the image feature of the content is handed over to the barcode visual expression determination section 12.

The barcode visual expression determination section 12 contains a specific image search section 121b and specific image feature dictionary 122b. The specific image feature dictionary 122b stores image feature values of a plurality of specific images. The specific image search section 121b searches the image feature of the contents obtained from the contents feature extracting section 11 to find out the image features corresponding to the image feature values of these specific images (Step S32b), and determines the presence or absence of the corresponding specific image (Step S33b).

The barcode visual expression determination section 12 further includes an expression pattern search section 123b and expression pattern dictionary 124b. The expression pattern dictionary 124b stores an expression pattern image for each of the specific images. If there is a specific image extracted by the specific image search section 121b, the expression pattern search section 123b searches the expression pattern dictionary 124b to find out the corresponding expression pattern image (Step S34), and extracts the corresponding expression pattern image (Step S35).

The barcode image generation section 13 includes a color pattern image generating section 131, color pattern masking section 132 and image synthesizing section 133. The color pattern image generating section 131 generates the color pattern image as a basic barcode image based on the barcode ID (URL) (Step S41). The color pattern image can be created by a commonly known method. The method known as color zip specifications is used here.

In the meantime, the color pattern masking section 132 masks the color pattern image (Step S42). This is intended to make a correction to ensure that color pattern image, namely, the information contained in the barcode will not be damaged, when the expression pattern image is synthesized later.

The image synthesizing section 133 superimposes an expression pattern image to the color pattern image (Step S43). The expression pattern image is formed in a visual expression such as a character and provides a barcode with a visual expression (e.g., the character of the expression pattern can be read).

The image synthesizing section 133 further superimposes the masked color pattern image obtained in Step S42 onto the superimposed color pattern image obtained in Step S43 (Step S44). Thus, even if the information is damaged in the first synthesis, the damage can be repaired. In the synthesis, various adjustments are made to maintain information (Step S45). The details of the adjustment are the same as those described with reference to FIG. 8.

The aforementioned procedure generates a barcode image as an output of the barcode image generating apparatus 10 (Step S46).

The description of the generation of the barcode image is now complete.

### <Example of Generating the Barcode Image by Barcode Image Generating Apparatus 10>

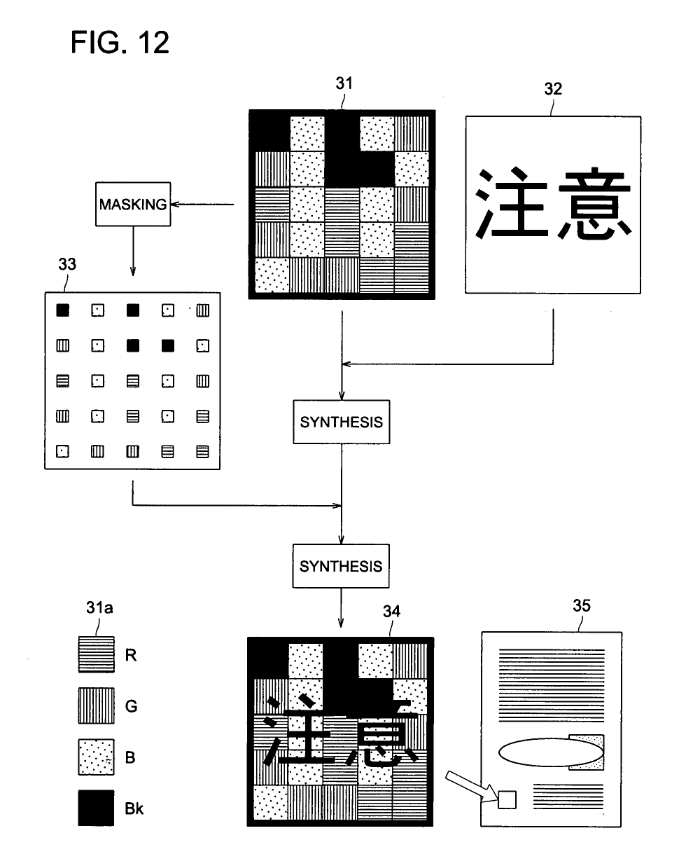

Referring to FIG. 12, the following describes an example of generating the barcode image by the barcode image generating apparatus 10 of the printer 2. FIG. 12 is a diagram showing the process of giving a visual expression to a barcode image by generating the color barcode and superimposing an expression pattern thereon. This process corresponds to the operation of processing in the flow chart of FIG. 6.

These descriptions are basically the same as those of the printer 1 as the first embodiment. The following describes only the difference.

Assume the following procedure in the preceding step: The specific image feature dictionary 122b stores feature values of unpleasant images as specific images, and matching with the contents image feature is found by the specific image search section 121b. Further, a specific image “UNPLEASANT IMAGE” is determined to be included, according to its frequency and other selection standards.

Assume further that the expression pattern dictionary 124b is searched by the expression pattern search section 123b, and an expression pattern “CAUTION” is found out in response to the specific image “UNPLEASANT IMAGE”. the expression pattern is converted based on the appropriate font dictionary (not illustrated) and others, and the expression pattern image 32 including the letters “ATTENTION” designed thereon is extracted. The expression pattern image 32 represents a Japanese kanji character denoting “ATTENTION”. These characters contain the intension of visually appearing that it is literally “requiring caution”. This is superimposed on the color barcode as a visual expression.

In the meantime, in Step S41 of FIG. 6, a color pattern image 31 as a basic barcode image is created by the color pattern image generating section 131 based on the barcode ID. Here it is assumed that a color barcode image is produced according to the color zip specifications.

The color zip specifications have already been discussed. The color pattern image 31 is made up of 5×5 cells, and four colors R, G, B and Bk (red, green, blue and black) shown in 31a are arranged in each cell.

In Step S42, the color pattern image 31 is masked to get a masked color pattern image 33. The process of masking is the same as that described above.

In Step S43, the expression pattern image 32 is superimposed on the color pattern image 31. Here the letters “CAUTION” are shown in a white patch. In other words, the process of synthesis is carried out so that the color information on that portion is lost.

In Step S44, the masked color pattern image 33 is further superimposed. As described above, the color arrangement on the portion essential to read out information is ensured.

Thus, the barcode image 34 containing a visual expression is obtained in Step S46.

This barcode image 34 is superimposed on the image for printing and is produces as a printed output. It is often used as a printed output 35 with barcode image.

The adjustment at the time of synthesis in Step S45 is the same as that described with reference to FIG. 8. The above description with reference to FIG. 9 also applies to the process of designing letters to eliminate the need of masking, and simple and efficient generation of a barcode image incorporating a visual expression can be similarly realized.

In the printer 2 incorporating a barcode image generating apparatus 10, the presence or absence of a specific image can be determined from the image feature contained in the contents, and the barcode image including a visual expression with an adequate character string designed thereon can be generated simply and effectively in response thereto. This can be produced as printed matter. The user of such a printed output is allowed to estimate the description of the contents that can be accessed from the barcode by observing a string of characters designed on the barcode. This eliminates the need of accessing an unwanted content, and ensure more effective access to desired contents.

### Third Embodiment

The following describes the printer 3 incorporating a barcode image generating apparatus as a third embodiment:

### <Structure and Operation Flow of Printer 3>

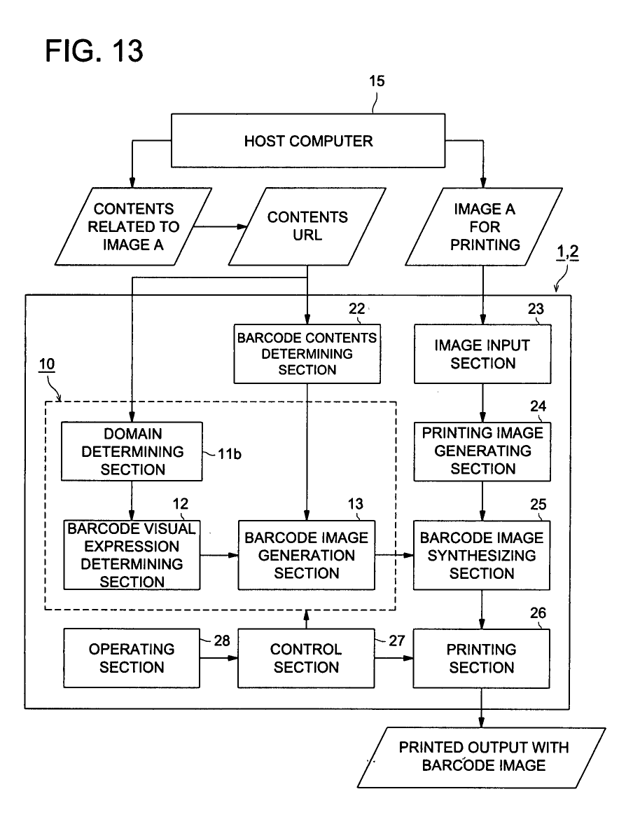

FIG. 13 is a block diagram representing the approximate structure of the printer 3 containing the barcode image generating apparatus of the third embodiment. The printer 3 only differs from the printers 1 and 2 in the details of the barcode image generating apparatus 10 and in lack of the content input section 21. The other parts are the same. Accordingly, the approximate structure of the printer 3 including the barcode image generating apparatus will be described briefly.

In FIG. 13, 10 denotes a barcode image generating apparatus. The barcode image generating apparatus 10 includes a domain determining section 11b, barcode visual expression determination section 12 and barcode image generation section 13.

The functions of the barcode image generating apparatus 10 have already been described. The domain determining section 11b serves as a feature input section for inputting a meaningful feature (domain) from the contents. The barcode visual expression determination section 12 serves as a visual expression determination section to determine the visual expression specifications from the contents feature. The barcode image generation section 13 serves as a barcode image generation section of the present invention for generating a barcode image based on the barcode ID and visual expression specifications.

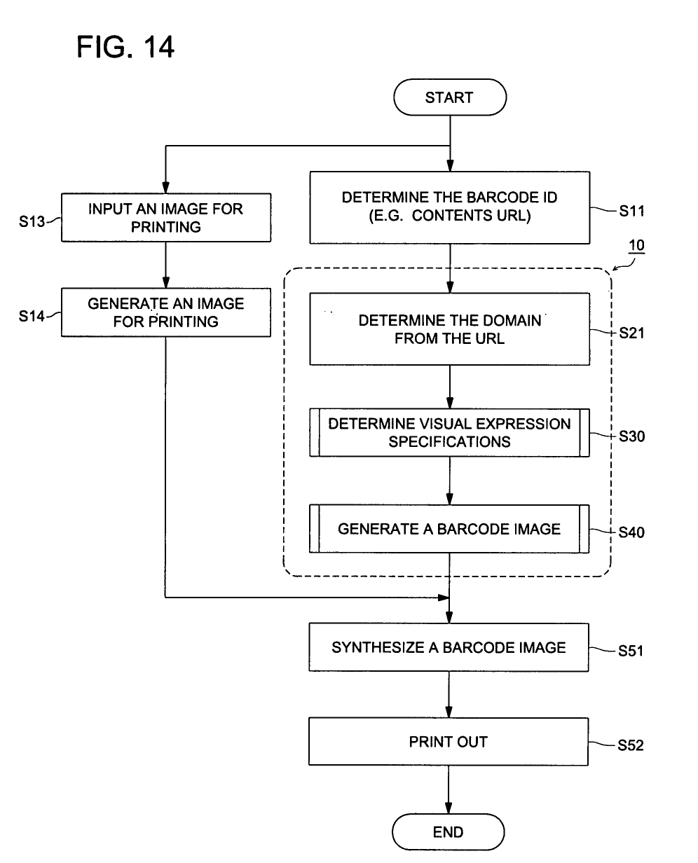

FIG. 14 is a flow chart representing the operation flow of the printer 3 containing the barcode image generating apparatus of the third embodiment. The operation of the printer 3 differs from that of the printers 1 and 2 in the details of Step S20, Step S30 and Step S40 with reference to the barcode image generating apparatus 10, and in lack of content input of Step S12. The other parts are the same. Accordingly, the operation flow of the printer 3 including the barcode image generating apparatus will be described briefly.

Step S21 is a feature input process. The domain determining section 11b extracts the meaningful feature (domain) from the contents URL. Step S30 is a visual expression determining process, and the barcode visual expression determination section 12 determines the visual expression specifications from the content feature (domain). Step S40 is a barcode image generating process, and the barcode image generation section 13 generates the barcode image according to the barcode ID and visual expression specifications.

The following describes the portions wherein FIG. 13 and FIG. 14 are different from FIG. 2 and FIG. 3, except for the portion related to the barcode image generating apparatus 10.

After the content URL has been acquired as a barcode ID by the barcode contents determining section 22, the URL as a barcode ID is handed over to the barcode image generating apparatus 10. At the same time, the content URL is also handed over thereto, and the domain is identified from the URL by the domain determining section 11b.

Accordingly, since the URL domain is used as the meaningful feature on the content, the content input section 21 is not necessary, and the contents input in Step S12 is not needed, either.

### <Structure and Operation Flow of Barcode Image Generating Apparatus 10>

The following describes the greater details of the structure and operation flow of the barcode image generating apparatus of the printer 3 with reference to drawings:

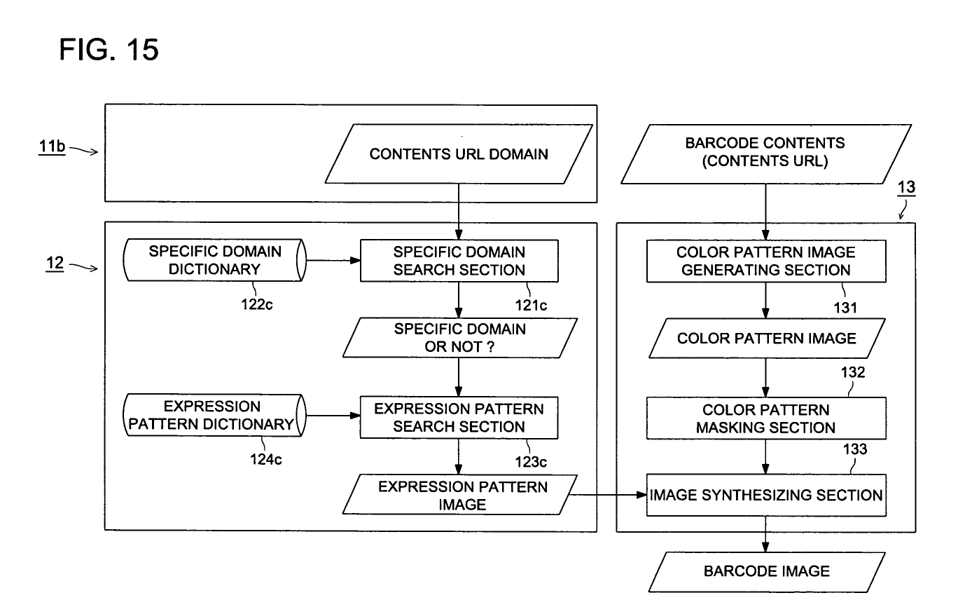

FIG. 15 is a block diagram representing the approximate structure of the barcode image generating apparatus 10 with reference to a printer 3. The following describes the approximate structure of the barcode image generating apparatus 10 with reference to FIG. 15:

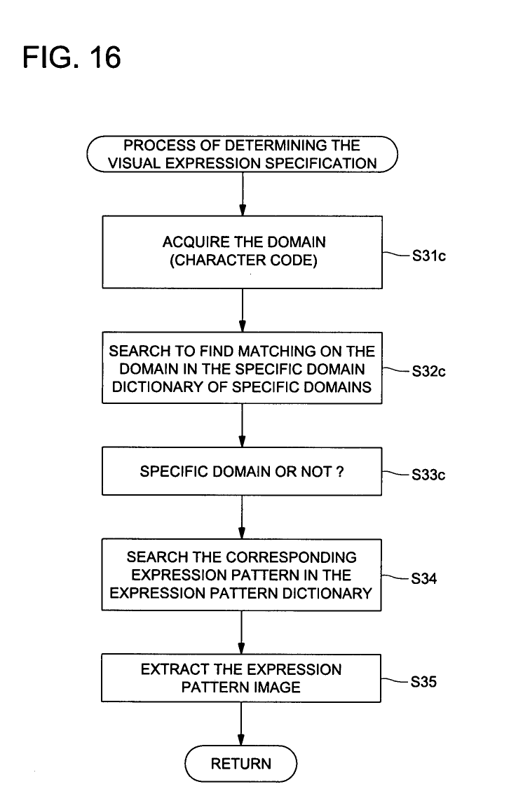

Referring to FIG. 16 and FIG. 6, the following describes the operation flow of each process:

FIG. 16 is a flow chart representing the operation flow of the process of determining visual expression corresponding to Step S30 of FIG. 14. FIG. 6 is a flow chart showing the operation flow in the process of generating the barcode image corresponding to the Step S40 of FIG. 3.

The barcode image generating apparatus 10 of FIG. 15 includes a domain determining section 11b, barcode visual expression determination section 12, and barcode image generation section 13.

The domain determining section 11b extracts the domain as a meaningful feature from the contents URL having been obtained. In the first place, in Step S31c, the contents domain is handed over to the barcode visual expression determination section 12.

The barcode visual expression determination section 12 includes a specific domain search section 121c and a dictionary 122c of specific domains. The dictionary 122c of the specific domains stores a plurality of specific domains, and the specific domain search section 121c searches the dictionary 122c of the specific domains to find out the domain matching the domain of the contents obtained from the domain determining section 11b (Step S32c). A decision step is taken to determine whether or not it corresponds to the specific domain (Step S33c).

The barcode visual expression determination section 12 further includes an expression pattern search section 123c and expression pattern dictionary 124c. The expression pattern dictionary 124c stores an expression pattern image for each of the specific domains. If a specific domain has been identified by the specific domain search section 121c, the expression pattern search section 123c searches the expression pattern dictionary 124c to find out the corresponding expression pattern image (Step S34), and extracts the corresponding expression pattern image (Step S35).

The barcode image generation section 13 is provided with a color pattern image generating section 131, color pattern masking section 132 and image synthesizing section 133. Their functions and the processes from Step S41 through Step S46 in the process of generating a barcode image shown in FIG. 6 are the same as those described with reference to the printers 1 and 2, and will not be described to avoid duplication.

Description of the generation of a barcode image is now complete.

The example of generating the barcode image by the barcode image generating apparatus 10 is the same as those of the printers 1 and 2, and will not be described to avoid duplication.

In the first and second embodiments, the expression pattern image is created by identifying the description of the contents. When the URL contained in the barcode includes meaningful information, there is no need for referring to the description of the contents. For example, the URL domain name is significant to the user in estimating the content. In the printer 3 as the third embodiment, the domain is used as a meaningful feature of the content.

As described above, in the printer 3 equipped with the barcode image generating apparatus 10, the domain name included in the contents URL is utilized. This eliminates the need of referring to the description of the contents, and permits simple and effective generation of a barcode image containing a visual expression with a string of appropriate characters designed thereon. The user of such a printed output is allowed to estimate the description of the contents that can be accessed from the barcode by visually observing a string of characters designed on the barcode. This eliminates the need of accessing an unwanted content, and ensure more effective access to a desired content.

### Fourth Embodiment

The following describes the printer 4 including the barcode image generating apparatus as a fourth embodiment.

### <Structure and Operation Flow of Printer 4>

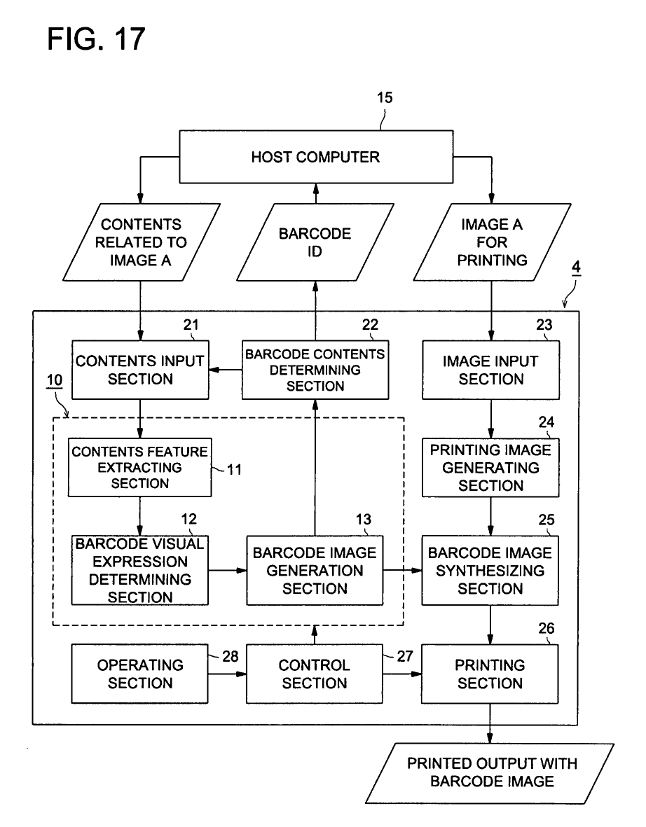

FIG. 17 is a block diagram representing the approximate structure of the printer 4 containing the barcode image generating apparatus of the fourth embodiment. The difference of the printer 4 from the printers 1 and 2 is found only in the barcode image generating apparatus 10, and the other ports are the same. Thus, the approximate structure of the printer 4 incorporating the barcode image generating apparatus will not be described.

In FIG. 17, 10 indicates a barcode image generating apparatus. The barcode image generating apparatus 10 includes a contents feature extracting section 11, barcode visual expression determination section 12 and barcode image generation section 13.

The functions of the barcode image generating apparatus 10 have already described. The contents feature extracting section 11 serves as a feature input section for inputting the significant feature from the content input, and the barcode visual expression determination section 12 serves as a visual expression determination section for determining the visual expression specifications from the content feature. The barcode image generation section 13 serves as a barcode image generation section of the present invention for generating a barcode image, based on the barcode ID and visual expression specifications.

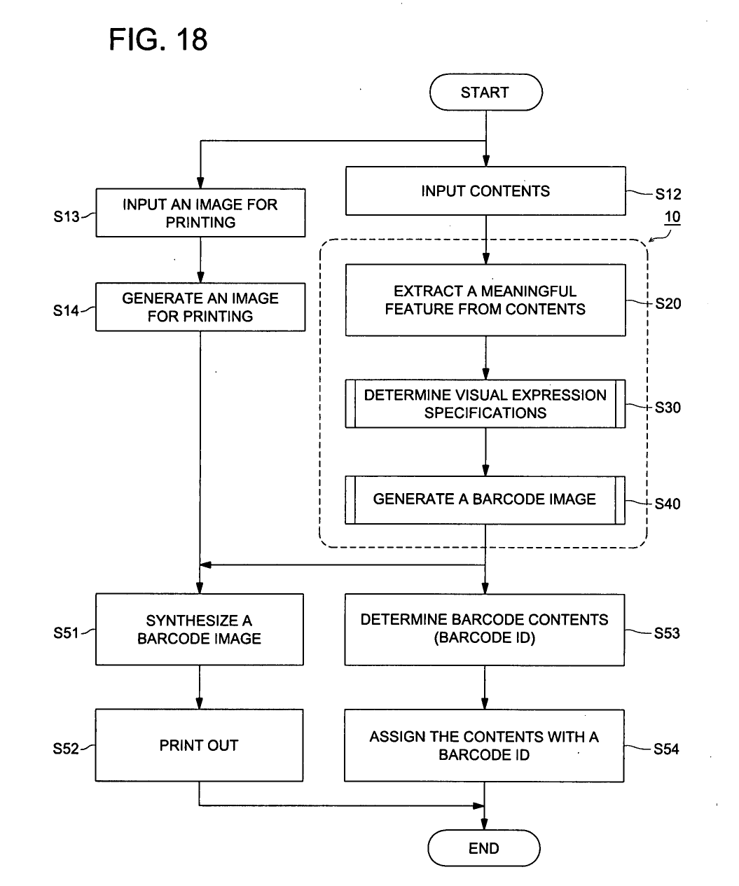

FIG. 18 is a flow chart representing the operation flow of the printer 4 containing the barcode image generating apparatus as a fourth embodiment. The difference between the operation of the printer 4 and those of the printers 1 and 2 is found in that the contents in the Step S20, Step S30 and Step S40 of the barcode image generating apparatus 10, and the contents of the barcode determined by the barcode contents determining section 22 are not given from the contents such as URL prior to generation of the barcode image; conversely, the barcode ID is determined in response to the barcode to be generated, and is assigned to the contents as an ID. Thus, the operation flow of the FIG. 18 will be described with the major emphasis placed on the main difference of the flow order from those of the printers 1 and 2.

In the first place, the picture image of the content is inputted through the content input section 21 in Step S12. Unlike the case with the printers 1 and 2, the barcode ID is not yet determined in this stage. The URL should be acquired to input the content, if required.

In the meantime, in Step S13, the image A for printing is acquired by the image input section 23. In the next Step S14, acquired image A for printing is converted into the image data to be printed, by the printing image generating section 24. This is the same as the cases with the printers 1 and 2.

According to the picture image of the contents obtained in Step S12, a barcode image is generated in the next Step S20, Step S30 and Step S40. To be more specific, the Step S20, Step S30 and Step S40 indicate the operation of generating the barcode image by the barcode image generating apparatus 10.

Step S20 is a feature input process. The contents feature extracting section 11 extracts a significant feature from the content input. Step S30 is a visual expression determining process, and the barcode visual expression determination section 12 determines the visual expression specifications from the content feature. Step S40 is a barcode image generating process, and the barcode image generation section 13 generates a barcode image according to the barcode ID and visual expression specifications.

The step of processing by the aforementioned barcode image generating apparatus 10 is basically the same as those of the printers 1 and 2. It should be noted, however, that, in Step S30 as will be described later, a barcode image is generated by the barcode image generation section 13, and the corresponding barcode ID is determined according to the visual expression specifications. To be more specific, the barcode ID is determined from the barcode image having a visual expression.

Thus, in the next Step S53, the barcode ID is handed over to the barcode contents determining section 22. In Step S54, the barcode ID as contents of the barcode is sent to the host computer 15, and is assigned to the contents as a barcode ID.

In the meantime, in the next Step S51, the barcode image generated by the barcode image generating apparatus 10 is superimposed with the image for printing obtained in Step S14, by the barcode image synthesizing section 25. The synthesized image A for printing with a barcode is printed out by the printing section 26 in the final Step S52.

### <Structure and Operation Flow of Barcode Image Generating Apparatus 10>

The following describes the greater details of the structure and operation flow of the barcode image generating apparatus 10 of the printer 4 with reference to drawings:

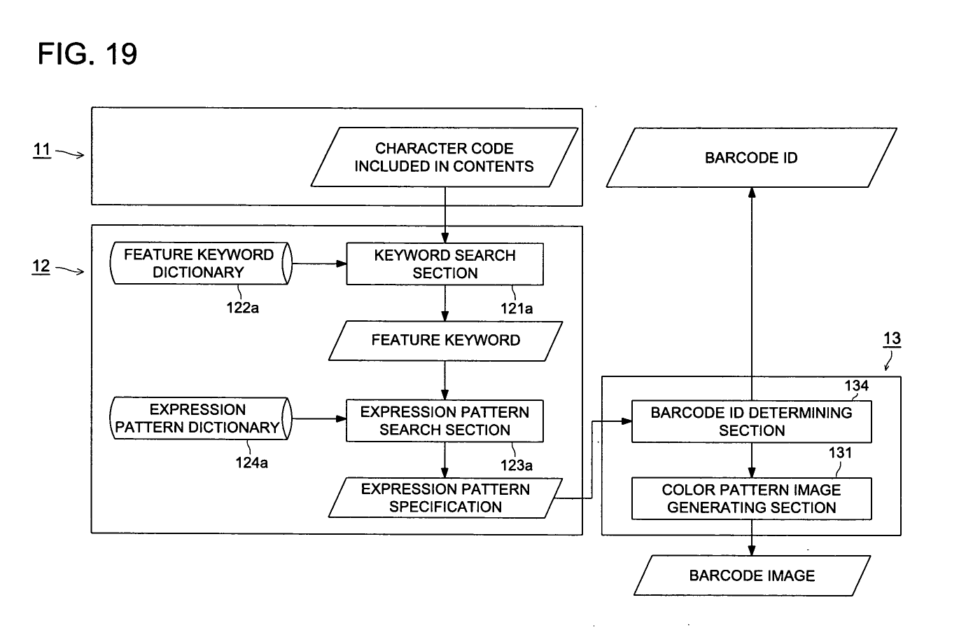

FIG. 19 is a block diagram representing the approximate structure of the barcode image generating apparatus 10 with reference to a printer 4. Referring to FIG. 19, the following describes the approximate structure of the barcode image generating apparatus 10:

The barcode image generating apparatus 10 of FIG. 19 includes a contents feature extracting section 11, barcode visual expression determination section 12 and barcode image generation section 13.

The internal structure of the contents feature extracting section 11 and barcode visual expression determination section 12 is the same as those of the printers 1 and 2 as the first embodiment, and will not be described to avoid duplication.

The barcode image generation section 13 is provided with a barcode ID determining section 134, and color pattern image generating section 131, unlike the cases of the printers 1 and 2. The barcode ID determining section 134 determines the barcode ID according to the specifications of the expression pattern received from the barcode visual expression determination section 12.

The following describes the operation flow:

The feature input process in the Step S20 of FIG. 18 by the contents feature extracting section 11 is the same as those of the printers 1 and 2, and will not be described to avoid duplication. The visual expression determining process in Step S30 by the barcode visual expression determination section 12 is also the same as those of the printers 1 and 2, which have already been described with reference to FIG. 5.

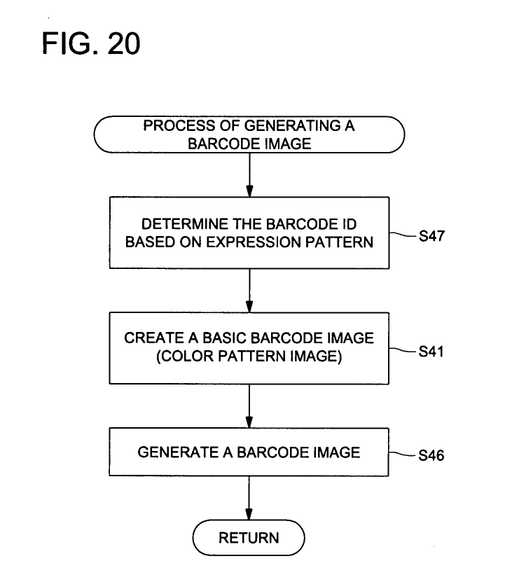

The barcode image generating process in Step S40 by the barcode image generation section 13 is different from those of the printers 1 and 2. Referring to FIG. 20, the following describes the operation of generating a barcode image. FIG. 20 is a flow chart showing the operation flow of the process of generating a barcode image in Step S40 of FIG. 18.

In FIG. 20, in the first place, the barcode ID is determined by the barcode ID determining section 134 according to the specifications of the expression pattern in Step S47. For example, when the pattern tincture is designated as the specifications of the expression pattern in response to the content feature, the ID which is selected from among a plurality of Ids of color pattern images and corresponds to the tincture is determined as the barcode ID.

In Step S41, the color pattern image corresponding to the barcode ID selected in Step S47 is generated by the color pattern image generating section 131. This is a basic barcode image. However, since the one meeting the specifications of the expression pattern is already selected, this color pattern image is outputted as a barcode image in Step S46.

The process of generating the barcode image is now complete.

Up to the aforementioned third embodiment, the URL or the like that can refer to the contents directly has been set as a barcode ID. It is also possible to specify the contents indirectly from the barcode and referring it wherein the unique ID capable of referring to the content is assumed as the contents of the barcode. In this case, selection can be made from various types of unique IDs and, conversely, the color pattern image of the barcode can be selected and changed by selecting a unique ID. To be more specific, the color pattern of the barcode can be controlled in response to the contents by selecting a unique ID of the barcode conforming to a desired visual expression.

In the barcode image generating apparatus of the present embodiment, for example, “For Male User” or “For Female User” is determined as a contents feature from the character code or image feature. The “Blue-based pattern” or “Red-based pattern” specification is respectively designated as a corresponding expression pattern.

According to this expression pattern specification, the barcode ID determining section 134 selects an appropriate unique ID from the unique IDs generating the “Blue-based pattern” or the unique IDs generating the “Red-based pattern” that meets the specification, namely, that can be utilized. The color pattern image generating section 131 generates a color pattern image as the “Blue-based pattern” or “Red-based pattern” corresponding to that ID.

As described above, in the printer 4 equipped with a barcode image generating apparatus 10, the unique ID is outputted to the host computer and is assigned to the contents, thereby ensuring simple and effective generation of the barcode image containing a diversified, easy-to-understand visual expression without the need of masking or synthesis. The resulting image can be formed into printed matter. The user of such a printed output is allowed to estimate the description of the content that can be accessed from the barcode, by visually observing the design of the barcode. This eliminates the need of accessing an unwanted content, and ensure more effective access to a desired content.

In the aforementioned embodiments, a barcode image generating function is incorporated in the printer. Further, the barcode image generating apparatus can be used independently. Alternatively, the barcode image generating apparatus can be included in another apparatus, or can be connected with a printer or external apparatus directly or via the network. Further, the barcode image can be generated for use with a server, web-oriented homepage or PDF document. Alternatively, it can be stored or used as electronic data, or displayed on the terminal apparatus for the PDA and electronic paper. In this manner, it can be used for various forms of applications. Thus, the barcode image generating apparatus can be used for various purposes depending on the particular requirement.

The aforementioned arrangement allows the barcode user to estimate the result of reading the barcode in advance by visually observing the visual expression designed on a barcode and hence to read the barcode free from anxiety. This eliminates the need of unwanted reading, and ensures effective access to desired information.

The present embodiment ensures simple generation of the barcode image containing the adequate visual expression conforming to barcode contents by extracting the meaningful feature related to the barcode contents, based on which a visual expression specification is determined, thereby generating a barcode image conforming to the visual expression specification.

What is claimed is:

1. A barcode image generating apparatus, comprising:
a barcode image generation section which generates a barcode based on a barcode ID;
a feature input section which inputs a meaningful feature related to the barcode image; and
a visual expression determination section which determines a visual expression specification of the barcode image based on the meaningful feature inputted by the feature input section,
wherein the barcode generating section generates a basic barcode image based on the barcode ID, and generates the barcode by having the visual expression specification determined by the visual expression determination section be reflected in the basic barcode.

2. The barcode image generating apparatus of claim 1, wherein the barcode image generation section determines the barcode ID based on the visual expression specification.

3. The barcode image generating apparatus of claim 1, wherein the feature input section extracts and inputs a meaningful feature of contents referred by the barcode image.

4. The barcode image generating apparatus of claim 3, the feature input section extracts the meaningful feature by searching one of or a combination of an image data and a character-string included in the contents and a meaningful character-string included in an address indicating the contents.

5. The barcode image generating apparatus of claim 4, wherein the visual expression determination section searches one of or a combination of a feature keyword, presence or absence of a particular image, and a particular domain based on the meaningful feature inputted by the feature input section, and determines an expression pattern as the visual expression specification of the barcode image based on a searched result.

6. The barcode image generating apparatus of claim 1, wherein an expression pattern as the visual expression specification of the barcode image restricts coloration of the barcode image.

7. The barcode image generating apparatus of claim 6, wherein the expression pattern as the visual expression specification of the barcode image includes one of or a combination of an expression specification which contains at least one of coloration, size, shape, and circumferential color of each cell constituting the barcode image, and an expression specification which contains at least one of a design showing a letter and a figure of the whole barcode image, a background of the cell, and a boundary between the barcode image and a surround thereof.

8. The barcode image generating apparatus of claim 1, wherein the barcode image generation section generates the barcode image by synthesizing the basic barcode image, a mask image for generating a barcode, and an expression pattern as the visual expression specification determined by the visual expression determination section.

9. A method of generating a barcode image, the method comprising the steps of:
generating the barcode image based on a barcode ID;
inputting a meaningful feature related to the barcode image; and
determining a visual expression specification of the barcode image based on the meaningful feature inputted in the step of inputting a meaningful feature,
wherein in the step of generating a barcode image, generating a basic barcode image based on the barcode ID, and generating the barcode by having the visual expression specification determined by the visual expression determination section be reflected in the basic barcode.

10. The method of claim 9, wherein in the step of generating the barcode image, determining the barcode ID based on the visual expression specification.

11. The method of claim 9, in the step of inputting a meaningful feature, extracting and inputting a meaningful feature of contents referred by the barcode image.

12. The method of claim 11, in the step of inputting a meaningful feature, extracting the meaningful feature by searching one of or a combination of an image data and a character-string included in the contents and a meaningful character-string included in an address indicating the contents.

13. The method of claim 12, in the step of determining a visual expression specification, searching one of or a combination of a feature keyword, presence or absence of a particular image, and a particular domain based on the meaningful feature inputted by the feature input section, and determining an expression pattern as the visual expression specification of the barcode image based on a searched result.

14. The method of claim 9, wherein an expression pattern as the visual expression specification of the barcode image restricts coloration of the barcode image.

15. The method of claim 14, wherein the expression pattern as the visual expression specification of the barcode image includes one of or a combination of an expression specification which contains at least one of coloration, size, shape, and circumferential color of each cell constituting the barcode image, and an expression specification which contains at least one of a design showing a letter and a figure of the whole barcode image, a background of the cell, and a boundary between the barcode image and a surround thereof.

16. The image of claim 9, wherein in the step of generating a barcode image, generating the barcode image by synthesizing the basic barcode image, a mask image for generating a barcode, and an expression pattern as the visual expression specification determined by the visual expression determination section.
